(19) United States
(12) Patent Application Publication
(10) Pub. No.: US 2003/0208947 A1
(43) Pub. Date: Nov. 13, 2003

(54) Fish strike indicator

(76) Inventor: Daniel Paul Cramer, Howard, PA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/143,681

(22) Filed: May 9, 2002

(51) Int. Cl. A01K 85/01; A01K 93/00; A01K 97/12

(52) U.S. Cl. 43/17

(57) ABSTRACT

A fishing apparatus comprises the combination of a fishing pole to which is engaged a fishing-line terminating with a fishing hook, the fishing line extending from the fishing pole for luring fish to the fishing hook; and a fish-strike indicator comprising an enclosure, an illumination device within the enclosure, a tether-line fixed at a distal end to the enclosure, and a line securement adapted for engaging the fishing line prior to a fish strike and further adapted for disengaging from the fishing line upon a fish strike.

### BACKGROUND OF THE INVENTION

1. Field of the Invention

This invention relates generally to fish strike indicating devices and more particularly to a fish strike indicator used in combination with a fishing pole to indicate that a fish has become snagged on a fishing line but which disengages when the fishing line is pulled.

2. Description of Related Art

The following art defines the present state of this field:

Ardizzone, U.S. Des. No. 211,636 describes a combined fishing rod support and alarm mount.

Lake et al., U.S. Pat. No. 3,453,767 describes a fish bite indicator comprising a housing having a top panel, a bottom panel, a rear panel and a front opening; a cover plate removably mounted on said housing to cover said opening; an actuator rod translatably mounted on said cover plate for movement perpendicular thereto, said rod having a forked outer end to support a fish pole inclined thereon and an inner end within said housing; a leaf spring mounted interiorly on said housing, said leaf spring biasing said inner end of said rod in an outward direction; a battery in said housing; a warning member on said housing; and, electrical conductor means connected to said battery, said spring and said warning member for actuating said warning member as said rod is translated against the bias of said spring by a supervening force acting inwardly on said forked outer end of said rod, said electrical conductor means including an electrical contact on said rear panel located for engagement with said spring as said spring is biased inwardly by said supervening force.

Williams, U.S. Pat. No. 4,178,712 describes a line-actuated fishing rod light including an electrically conductive bracket, a battery therein, a threaded-base, bulb, and a spring wire trigger arm coiled to provide a socket for the bulb and extending beyond the socket to form a trigger finger. A fishing line is wrapped around the finger and, upon a fish strike, pulls the arm and socket toward a battery terminal. The bulb lights on contact of its terminal with the battery, through the circuit provided by the battery's rear terminal, a rear wall of the bracket, the bracket, the spring wire arm, the coil socket, and the bulb base. The line disengages from the trigger arm upon playing the fish, so that the light does not interfere with the line during such time. Also, the bulb can be rotated into and out of the coil socket to adjust the light's sensitivity to differing forces exerted on the line.

Klefbeck, U.S. Pat. No. 4,528,554 describes a signalling device that can be attached to a fishing rod and an ice fishing tip up, to alert the angler to the strike or biting of a fish, by means of an oscilating luminous signal. A cylindrical housing having a removable circuit breaking plug or insert said plug incorporating an attached slotted ring to comfortably retain fishing line and to loop around the flag stem hanger of a tip up. The pressure of a hooked fish removes the plug which completes the circuit thus illuminating the signal.

Miller, U.S. Pat. No. 4,730, 408 describes a device which holds a fishing rod and automatically sets a fishhook in a fish. A stake driven into the ground supports a pivot arm on which the rod is held. A trip lever holds the arm in position for fishing and is released by a trigger wire when the fishing line is subjected to a pulling force caused by a strike on the bait. A spring then pivots the arm upwardly in an abrupt and forceful manner to set the fishhook.

Zepeda, WO 95/26630 describes a fish bite indicator in combination with a fishing rod and reel to give an audible and/or visual signal when the fishing line is under tension. An arm of the indicator extends below the rod. The fishing line is threaded in a loop to cause the arm to move upward toward the rod when the line has sufficient tension to indicate a fish strike. The indicator includes an on/off switch, a switch activating arm that is attached to oscillating arm for activating the on/off switch, an alarm electrically connected to the switch for indicating the line is in tension, and a battery power source for the alarm.

The prior art teaches the use of fish strike indicators but does not teach such an indicator used in conjunction with a fishing line wherein the indicator dislodges from the line when a strike is made. The present invention fulfills these needs and provides further related advantages as described in the following summary.

### SUMMARY OF THE INVENTION

The present invention teaches certain benefits in construction and use which give rise to the objectives described below.

A fishing apparatus comprises the combination of a fishing pole to which is engaged a fishing-line terminating with a fishing hook, the fishing line extending from the fishing pole for luring fish to the fishing hook; and a fish-strike indicator comprising an enclosure, an illumination device within the enclosure, a tether-line fixed at a distal end to the enclosure, and a line securement adapted for engaging the fishing line prior to a fish strike and further adapted for disengaging from the fishing line upon a fish strike.

A primary objective of the present invention is to provide an apparatus and method of use of such apparatus that provides advantages not taught by the prior art.

Another objective is to provide such an invention capable of alerting a fisherman to a fish strike.

A further objective is to provide such an invention capable of being automatically disengaged from the fishing line upon a fish strike.

A still further objective is to provide such an invention capable of being illuminated for night fishing.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side elevational view of the preferred embodiment of the invention;

FIG. 2 is a front elevational view of an enclosure thereof; and

FIG. 3 is a sectional view of the enclosure taken along line 3-3 in FIG. 2.

### DETAILED DESCRIPTION OF THE INVENTION

The above described drawing figures illustrate the invention in at least one of its preferred embodiments, which is further defined in detail in the following description. The present invention is a fishing apparatus comprising the combination of a fishing pole 10 to which is engaged a fishing-line 20 terminating with a fishing hook 30. The fishing line 20 extends from the fishing pole 10 and generally has a lure or bait, or the like (not shown), for luring fish to the fishing hook 30. A fish-strike indicator 40 comprises an enclosure 50, an illumination means 60 positioned within the enclosure 50, a tether-line 70 fixed at its distal end 72 to the enclosure 50, and a line securement means 80 adapted for engaging the fishing line 20 prior to a fish strike and further adapted for disengaging from the fishing line 20 upon a fish strike.

Preferably, the enclosure 50 provides an eye 52 for attachment of the distal end 72 of the tether-line 70 as shown in FIG. 2. Preferably, the illumination means 60 includes a battery 62, a lamp 64 and an electrical interconnect 66 for providing a ground circuit. Preferably the enclosure 50 is made in two separate pieces 50A and 50B which are screwed together with a rubber seal 51 between to maintain the interior of the enclosure as water tight.

Preferably, the line securement means 80 is a receptacle, clearly shown in FIG. 3, adapted by its shape, for accepting the fishing-line 20, and it has a surface material 82, such as Velcro® hook surface material which is adapted for tentatively engaging the fishing line 20 so as to be able to release the fishing line 20 upon a fish strike which causes the line to be pulled out of the receptacle 80.

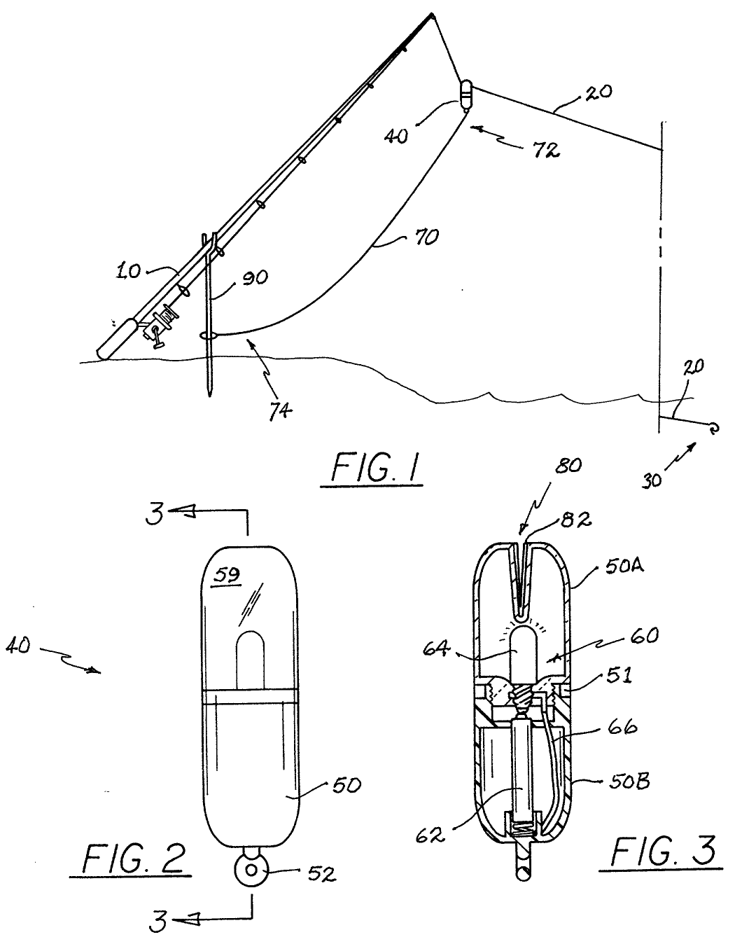

A fishing pole supporting means 90 such as a forked stick may be used and, as shown in FIG. 1, it may be adapted for engaging the fishing pole 10 in elevated abutment as is well known in the sport fishing industry.

Preferably a proximal end 74 of the tether-line 70 is engaged with the fishing pole supporting means 90, again, as shown in FIG. 1.

The enclosure 50 preferably has a portion 59 adapted for transmitting light therethrough so that the illumination may be seen by a fisherman.

In use, the combination is set-up as shown in FIG. 1 with the enclosure 50 is plain sight but tentatively attached to the fishing line 20. When a fish strikes, it pulls the fishing line 20 causing the enclosure 50 to disengage and alerting a fisherman to the fact that a fish is snagged on the fishing line 20. Because the enclosure 50 is attached by the tether-line to the supporting means 90, it is not pulled away from the shore and cannot become damaged or lost.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A fishing apparatus comprising in combination: a fishing pole to which is engaged a fishing-line terminating with a fishing hook, the fishing line extending from the fishing pole for luring fish to the fishing hook; and a fish-strike indicator comprising an enclosure, an illumination means within the enclosure, a tether-line fixed at a distal end thereof to the enclosure, and a line securement means adapted for engaging the fishing line prior to a fish strike and further adapted for disengaging from the fishing line upon a fish strike.

2. The combination of claim 1 wherein the enclosure provides an eye for attachment of the distal end of the tether-line.

3. The combination of claim 1 wherein the illumination means includes a battery, a lamp and an electrical interconnect for providing a ground circuit.

4. The combination of claim 1 wherein the line securement means is a receptacle adapted for accepting the fishing-line, the receptacle including a surface material adapted for tentatively engaging the fishing line so as to release the fishing line upon a fish strike.

5. The combination of claim 4 further comprising a fishing pole supporting means adapted for engaging the fishing pole in elevated abutment.

6. The combination of claim 4 wherein a proximal end of the tether-line is engaged with the fishing pole supporting means.

7. The combination of claim 1 wherein the enclosure has a portion adapted for transmitting light therethrough.
